(19) United States
(12) Patent Application Publication
(10) Pub. No.: US 2018/0073922 A1
(43) Pub. Date: Mar. 15, 2018

(54) COMPOSITION, FILM FOR ULTRAVIOLET LIGHT INTENSITY DETECTION, METHOD FOR PREPARING THE FILM AND METHOD FOR ULTRAVIOLET LIGHT INTENSITY DETECTION

(71) Applicants: BOE TECHNOLOGY GROUP CO., LTD., Beijing (CN); BEIJING BOE DISPLAY TECHNOLOGY CO., LTD., Beijing (CN)

(72) Inventors: Feifei WANG, Beijing (CN); Xibin SHAO, Beijing (CN); Ping SONG, Beijing (CN); Seung Min LEE, Beijing (CN); Honglin ZHANG, Beijing (CN); Hebin ZHAO, Beijing (CN); Deqiang LIU, Beijing (CN)

(21) Appl. No.: 15/677,105

(22) Filed: Aug. 15, 2017

(30) Foreign Application Priority Data
Sep. 9, 2016 (CN) 201610815079.2

(51) Int. Cl. G01J 1/50; G01J 1/02; C09K 19/50; C09K 19/36; C09K 19/58; C09K 19/54; C08F 2/50

(52) U.S. Cl. CPC G01J 1/50; G01J 1/0295; C09K 19/50; C09K 2019/546; C09K 19/586; C09K 19/542; C08F 2/50; C09K 19/36

(57) ABSTRACT

A composition for ultraviolet light intensity detection comprises nematic mixed crystals, chiral additives, cholesteric liquid crystals, azobenzene monomers, photopolymerizable monomers and a photoinitiators. When preparing a film having the composition, the steps include mixing each of components of the composition and spreading out the mixture to form a pre-formed film of the mixture, and irradiating the pre-formed film by light to form a film for ultraviolet light intensity detection.

### CROSS-REFERENCE TO RELATED APPLICATIONS

The present application claims priority to Chinese Patent Application No. 201610815079.2, filed Sep. 9, 2016, and entitled “composition, film for ultraviolet light intensity detection, method for preparing the film and method for ultraviolet light intensity detection”, the entire contents of which are incorporated herein by reference.

### TECHNICAL FIELD

The present disclosure relates to the field of optical detection technology, and more particularly to a composition, film for ultraviolet light intensity detection, a method for preparing the film and method for ultraviolet light intensity detection.

### BACKGROUND

A ultraviolet illuminometer is an instrument for measuring light intensity, also known as a luxmeter. By measuring the ratio of the luminous flux and the area being irradiated on the surface of an object, the illumination intensity of the object can be obtained.

The existing ultraviolet illuminometer is usually composed of a selenium photocell and a microammeter connected with the selenium photocell. When measuring, the photosensitive surface of the selenium photocell is placed under the irradiation of the ultraviolet light, so that the selenium photocell generates photo-generated current through photoelectric effect, and the photo-generated current can be measured by the microammeter. As the scale on the microammeter is in lux (Lx), the reading of microammeter is the intensity of the ultraviolet light after the photo-generated current generated by the selenium photocell under the irradiation of the ultraviolet light. However, when measuring the intensity of the ultraviolet light, the ULTRAVIOLET illuminometer can only measure a small area of ultraviolet light due to the limited area of the selenium photocell. For a large area of ultraviolet light, repeatedly tests are needed, resulting in a complex detection process.

### SUMMARY

The present disclosure provides a composition for ultraviolet light intensity detection comprising nematic mixed crystals, chiral additives, cholesteric liquid crystals, azobenzene monomers, photopolymerizable monomers and a photoinitiators.

The present disclosure also provides a film for ultraviolet light intensity detection, comprising the composition for ultraviolet light intensity detection provided by the above aspect.

The present disclosure also provides a method for preparing a film, which is used to prepare the film provided by the above aspect, comprising:

mixing the photopolymerizable monomer, the photoinitiator, the cholesteric liquid crystals, the azobenzene monomer, the nematic mixed crystal and the chiral additive to form a mixture; and

spreading the mixture to form a pre-formed film of the mixture, and irradiating the pre-formed film by light, so that polymerization reactions of photopolymerizable monomers is initiated by the photoinitiator in the mixture to form a film for ultraviolet light intensity detection.

The present disclosure also provides a method for ultraviolet light intensity detection, using the film provided by the above aspect or the film prepared by the method for preparing a film provided by the above aspect, comprising a calibration step, a test step and a result output step, wherein

the calibration step comprises irradiating the film by ultraviolet light with different intensities for a same calibration time to change a color of the film and obtain a calibration color of the film, and obtaining a correspondence relationship between different ultraviolet light intensities and the calibration colors of the film;

the test step comprises irradiating the film by ultraviolet light to be tested for a testing time to change a color of the film is changed and obtain a tested color of the film, wherein the testing time is the same as the calibration time;

the result output step comprises searching the calibration color of the film being the same as the tested color of the film from the correspondence relationship between different ultraviolet light intensities and the calibration colors of the film; and

according to the correspondence relationship between different ultraviolet light intensities and the calibration colors of the film, finding and determining the ultraviolet light intensity corresponded to the tested color of the film, and the found ultraviolet light intensity corresponded to the tested color of the film is the intensity of the ultraviolet light to be tested.

### BRIEF DESCRIPTION OF THE DRAWINGS

The accompanying drawings provide a further understanding of the present disclosure and constitute a part of this disclosure. The illustrative embodiments of the present disclosure and its description are intended to illustrate the present disclosure and do not constitute an undue limitation to the present disclosure. In the drawings:

FIG. 1 is a cross-sectional view of a film for ultraviolet light intensity detection provided by the present disclosure;

FIG. 2 is a cross-sectional view of a film for ultraviolet light intensity detection after being irradiated by the ultraviolet light provided by the present disclosure;

FIG. 3 is a flow chart of a method of preparing a film for ultraviolet light intensity detection provided by the present disclosure;

FIG. 4 is a flow chart of a method for ultraviolet light intensity detection provided by the present disclosure;

FIG. 5 is a flow chart of the uniformity test of a method for ultraviolet light intensity detection provided by the present disclosure;

FIG. 6 is a spectrogram obtained by measuring the film provided by the present disclosure under the irradiation of the ultraviolet light for different time; and

FIG. 7 is a spectrogram obtained by measuring the film provided by the present disclosure irradiated by the ultraviolet light with different intensities for the same time.

### DETAILED DESCRIPTION

In order to further illustrate the composition, film for ultraviolet light intensity detection, the method for preparing the film and the method for ultraviolet light intensity detection provided by the present disclosure, the following description will be made in detail with reference to the accompanying drawings.

The composition for ultraviolet light intensity detection provided by the present disclosure comprises nematic mixed crystals, chiral additives, cholesteric liquid crystals, azobenzene monomers, photopolymerizable monomers and a photoinitiators.

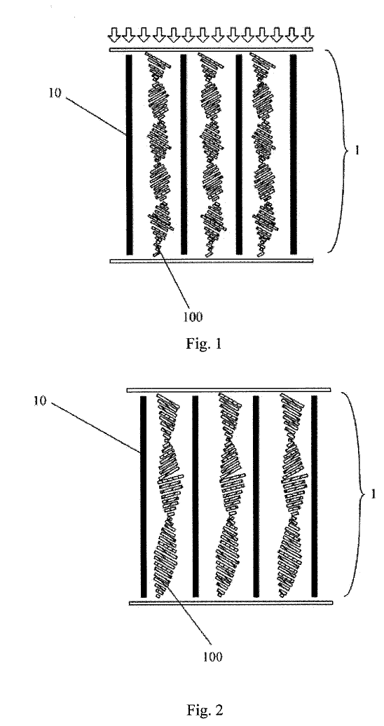

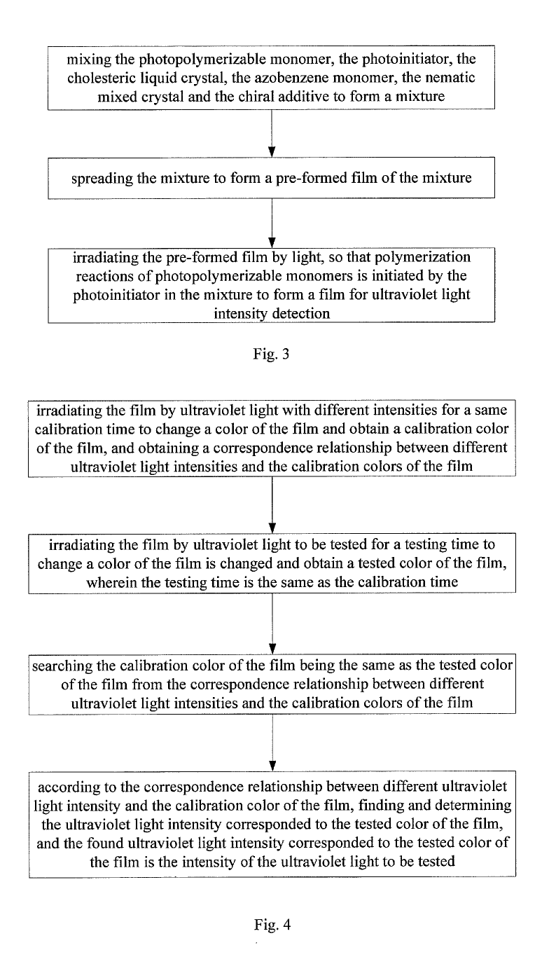

In the specific implementation, referring to FIG. 3, a film 1 for ultraviolet light intensity detection as shown in FIG. 1 is made from the composition by the following method.

The first step is to make a mixture. The photopolymerizable monomers, the photoinitiators, the cholesteric liquid crystals, the azobenzene monomers, the nematic mixed crystals and the chiral additives are mixed uniformly to form the mixture.

The second step is to prepare a film. The mixture is spread out to form a pre-formed film of the mixture. The pre-formed film is irradiated by the ultraviolet light to obtain a film 1 for ultraviolet light intensity detection as shown in FIG. 1. The mixture can be spread out to form a pre-formed film of the mixture in a variety of ways. For example, the mixture can be spread out on the surface of a substrate to form the pre-formed film of the mixture on the surface of the substrate. Alternatively, the mixture can also be filled into a transparent box body so that the mixture can be spread out in the transparent box body. Thus, the pre-formed film of the mixture can be formed in the transparent box body.

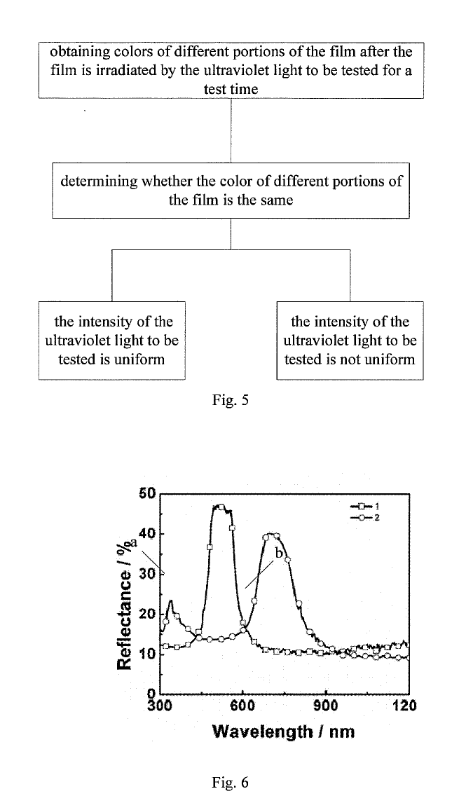

Referring to FIG. 5, a method for the ultraviolet light intensity detection using the film comprises a calibration step, a test step and a result output step.

The calibration step comprises the following step. The film is irradiated by the ultraviolet light with different intensities for a same calibration time, thus the color of the film is changed and a calibration color of the film is obtained, and a correspondence relationship between different ultraviolet light intensities and the calibration colors of the film is obtained.

The test step comprises the following steps. The film is irradiated by ultraviolet light to be tested for a testing time, thus the color of the film is changed and a tested color of the film is obtained, wherein the testing time is the same as the calibration time.

The result output step comprises the following steps. The calibration color of the film tested which is the same as the tested color of the film is searched from the correspondence relationship between different ultraviolet light intensities and the calibration colors of the film; and

according to the correspondence relationship between different ultraviolet light intensities and the calibration colors of the film, the ultraviolet light intensity which is corresponded to the tested color of the film is found and determined, and the found ultraviolet light intensity which corresponds to the tested color of the film is the intensity of the ultraviolet light to be tested.

Specifically, referring to FIGS. 1 and 2, the principles of using the composition to perform the ultraviolet light intensity detection are as follows. The nematic mixed crystal which is added with the chiral additives can has the same characteristics as the cholesteric liquid crystals, that is, the molecules of the nematic mixed crystal have a certain pitch. For example, the molecules of the nematic mixed crystal exhibit helical characteristics as that of the helical liquid crystal molecules 100 shown in FIG. 1. By adding azobenzene monomers to cholesteric liquid crystals mixture composed of nematic mixed crystals, chiral additives, and cholesteric liquid crystals, when the film formed by the composition is irradiated by the ultraviolet light, the optical heterogeneity of azobenzene monomer is changed and can affect pitches of the nematic mixed crystals and the cholesteric liquid crystals in the cholesteric liquid crystals mixture. Thus, referring to FIGS. 1 and 2, when the optical heterogeneity of azobenzene monomer is changed, pitches of the nematic mixed crystals and the cholesteric liquid crystals in the cholesteric liquid crystals mixture are changed accordingly. Due to changes of pitches of the nematic mixed crystals and the cholesteric liquid crystals in the cholesteric liquid crystals mixture, the film obtainable from the composition can reflect light with different wavelengths so that the film can exhibits different colors. That is, the changes of pitches of the nematic mixed crystals and the cholesteric liquid crystals in the cholesteric liquid crystals mixture can make the colors of the film made from the composition change visually. Therefore, the film formed by the composition can be first calibrated by ultraviolet light with different intensities to obtain a correspondence relationship between the film formed by the composition and the ultraviolet light intensities. When ultraviolet light detection is required, using the ultraviolet light to be tested to irradiate the film formed by the composition, the intensity of the ultraviolet light the film can be determined by the color of the film formed by the composition after being irradiated by the ultraviolet light. Moreover, since the film formed by the composition can be prepared according to the actually required size, it is possible to prepare films with different areas according to actual needs when performing ultraviolet light intensity detection. For example, it is possible to test the intensity of a large area of ultraviolet light at a time by using the film formed by the composition without repeated detection. Therefore, using the composition for ultraviolet light intensity detection provided by the present disclosure can improve the detection area of the ultraviolet light while simplify the process of the ultraviolet light intensity detection.

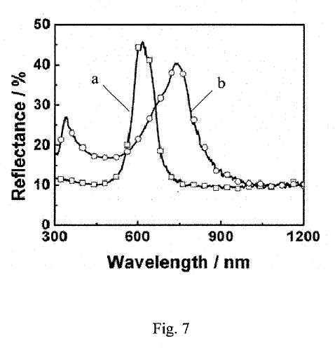

In one exemplary embodiment, FIG. 7 is a spectrogram obtained by measuring the film irradiated by two ultraviolet light beams with different intensities for same time (20 seconds). The curve a in FIG. 7 corresponds to an ultraviolet light having a wavelength of 365 nm and an intensity of 21.4 mw/cm². The curve b in FIG. 7 corresponds to an ultraviolet light having a wavelength of 365 nm and an intensity of 13.7 mw/cm². As shown in FIG. 7, the film is irradiated by the ultraviolet light with same wavelength but the different intensities, the corresponding reflectivity is different. That is, after the film is irradiated by the ultraviolet light with same wavelength but the different intensities, the reflectivity of the film is corresponded with the intensity of the ultraviolet light one by one. And the color of the film is associated with the reflectivity of the film by a one-to-one correspondence, therefore, the intensity of ultraviolet light can be determined by the color of the film irradiated by the ultraviolet light.

Moreover, the composition for ultraviolet light intensity detection provided by the present disclosure further comprises photopolymerizable monomers and photoinitiators. And before the composition is used to perform ultraviolet light intensity detection, under the irradiation of light, polymerization reactions of photopolymerizable monomers is initiated by the photoinitiators to form network polymers. Thus, during the process of the ultraviolet light intensity detection, after the optical heterogeneity of the azo benzene monomer is changed under the irradiation of the ultraviolet light to be tested, the network structures in the network polymers can temporarily stabilize the optical heterogeneity of the azo benzene monomer so that the pitches of the nematic mixed crystals and the cholesteric liquid crystals in the cholesteric liquid crystals mixture can be indirectly stabilized. In the case that the pitches of the nematic mixed crystal and the cholesteric liquid crystals in the cholesteric liquid crystals mixture are stabilized, the color of the film formed by the composition can be maintained so that the color of the film is observable. Since the network structures in the network polymers can temporarily stabilize the optical heterogeneity state of the azo benzene monomer, that is, the network structures in the network polymers can not keep stabilizing the optical heterogeneity state of the azo benzene monomer, after a certain period of time, the optical heterogeneity state of the azobenzene monomer will return to be its initial state. Therefore, the composition for ultraviolet light intensity detection provided by the present disclosure can be repeatedly used to detect the ultraviolet light intensity, greatly reducing the detection cost. Moreover, because each of components of the composition can be provided extensive sources, and the preparation process is simple, greatly reducing the detection costs.

Furthermore, since the photopolymerizable monomer undergoes a polymerization reaction, the resulting network-like polymer is solid-formed, in the film formed by the composition, the network polymer can not only temporarily stabilize the optical heterogeneity state of the azo benzene monomer when the ultraviolet light intensity is detected, and also cure the film when the film is prepared.

It is to be understood that, in the compositions provided in the present disclosure, the proportion of each of components can be set according to actual requirements and the composition can be used for ULTRAVIOLET light intensity detection as long as these components are present in the composition.

As an example, the mass ratio of the nematic mixed crystal, the chiral additive, the cholesteric liquid crystals, the azobenzene monomer, the photopolymerizable monomer and the photoinitiator in the composition is (26˜85.99):(5˜19):(0˜20):(2˜11):(7˜22): (0.01˜2).

It is to be noted that the clearing point temperature of the nematic mixed crystal in the composition provided in the present disclosure is 80° C.˜120° C. to ensure that the composition maintains liquid crystal properties in a normal environment.

As an example, the clearing point temperature of the nematic mixed crystal is 80.5° C.˜92° C. In a specific embodiment, there may be various types of nematic mixed crystals in the above-mentioned compositions, for example, one or more of SLC-1717, MAT 09-1284 and ZBE 5192. The SLC-1717, MAT 09-1284 and ZBE 5192 are the products of nematic mixed crystals.

The clearing point temperature of SLC-1717 is 92° C., the manufacturer is Shijiazhuang Chengzhi Yonghua Display Materials Co., Ltd.

The clearing point temperature of MAT 09-1284 is 80.5° C., the manufacturer is Germany Merck company.

The clearing point temperature of ZBE 5192 is 80.5° C., the manufacturer is JNC Petrochemical Co., Ltd., Japan.

Moreover, there may be various types of chiral additives in the composition provided by the present disclosure. For example, the chiral additive may be selected from a group consisting of

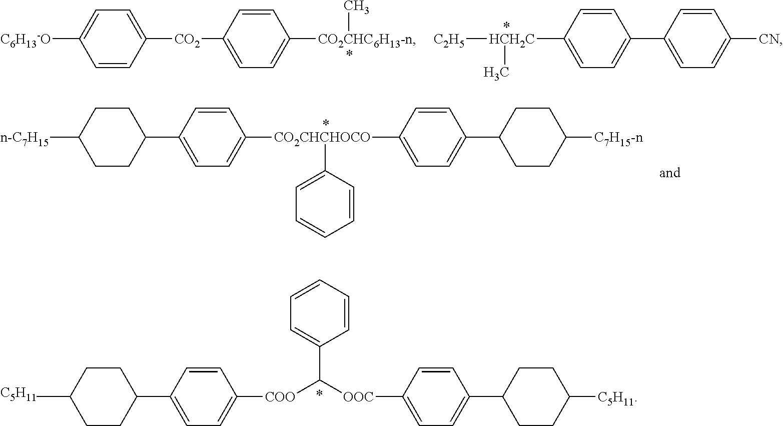

Similarly, there may be various types of cholesteric liquid crystals. For example, the cholesteric liquid crystals may be:

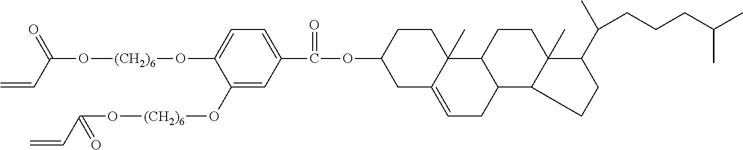

It is to be understood that, in the composition provided by the present disclosure, the optical rotation direction of the chiral additive can be consistent or inconsistent with that of the cholesteric liquid crystals. It is considered that, when the molal weight of the chiral additive is the same as that of the cholesteric liquid crystals, the inconsistent optical rotation directions of the chiral additive and the cholesteric liquid crystals will cause the problem of eliminating the optical rotation, thereby when the optical rotation state of the azo benzene monomer rotation state changes, the pitches of the nematic mixed crystal and the cholesteric liquid crystals in the cholesteric liquid crystals cannot change. Therefore, the optical rotation direction of the chiral additive is defined to consistent with that of the cholesteric liquid crystals to avoid the problem of eliminating the optical rotation completely.

Moreover, there may be various types of azobenzene monomers in the composition provided by the present disclosure. For example, the azobenzene monomer may be:

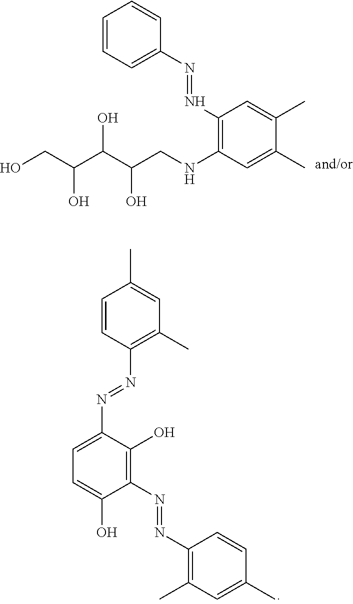 [SMILES: Cc1cc(/N=N/c2ccccc2)c(NCC(O)C(O)C(O)CO)cc1C ; Cc1ccc(/N=N/c2ccc(O)c(/N=N/c3ccc(C)cc3C)c2O)c(C)c1]

Similarly, there may be various types of photopolymerizable monomers. For example, the photopolymerizable monomer may be one or more of:

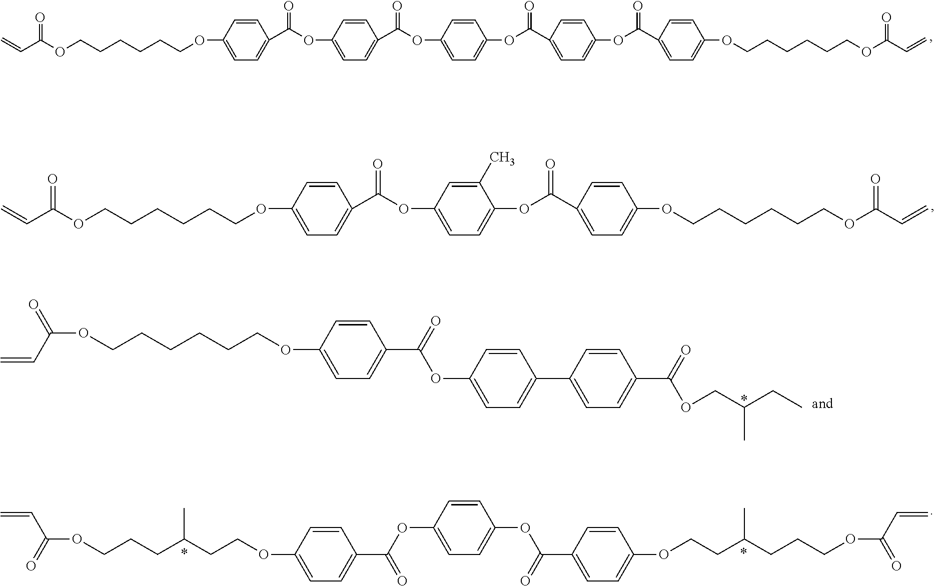

Correspondingly, the photoinitiator is selected from a group consisting of benzoin dicarboxylate, benzoin ethers and benzoin butyl ether.

The present disclosure also provides a film 1 comprising the composition provided by the above embodiment. The effect achieved by the film is the same as that of the abovementioned composition for ultraviolet light intensity detection, and this is not repeated here. Furthermore, the film may be a reticulated film formed by a number of preparation processes, such as a photomask, in which a macroscopically visualized mesh 10 is formed in the film, and the mesh contains helical liquid crystal molecules 100. This macroscopic visualization visualized mesh 10 is capable of stabilizing the optical heterogeneity state of the azo benzene monomer, thereby increasing the retention time of the optical heterogeneity of the azo benzene monomer, so that after the film is irradiated with ultraviolet light, the color of the film can be kept for a long period of time to reduce the observed error caused by slight changes in color when the film is visually observed.

Referring to FIG. 3, the present disclosure also provides a method of preparing said film, the method comprises the following steps.

For the first step, the photopolymerizable monomer, the photoinitiator, the cholesteric liquid crystals, the azobenzene monomer, the nematic mixed crystal and the chiral additive are mixed to form a mixture.

For the second step, the mixture is spread out to form a pre-formed film of the mixture. The pre-formed film is irradiated by light, so that polymerization reactions of photopolymerizable monomers is initiated by the photoinitiator in the mixture to form a film for ultraviolet light intensity detection.

The advantage of the method for preparing the film provided by the present disclosure is the same as that of the provided composition, and is not described here.

It is to be noted that, in the present disclosure, a photomask process can be used to allow light to pass through the photomask and then irradiate on the pre-formed film of the mixture to form a film with network structure. The network structure is a macroscopical network structure. However, the network structure of the network polymer formed after the polymerization of the photopolymerizable monomer is a structure at a molecular level, which is a characteristic possessed by the polymer molecule, so long as the polymerizable monomer can be polymerized, the network polymer is inevitably generated. Thus, the network structure of the network is at a microstate. Therefore, in the present disclosure, a photomask process can be used to form a film with both a structure at a molecular level and a macroscopical network structure. After the optical heterogeneity of azobenzene monomer is changed, the optical heterogeneity of azobenzene monomer can be stabilized by the network structure which is at microstate, and can further be stabilized by the macroscopical network structure. Thereby the retention time of the optical heterogeneity of the azo benzene monomer can be further increased, so that after the film is irradiated with ultraviolet light, the color of the film can be kept for a longer period of time to reduce the observed error caused by slight changes in color when the film is visually observed.

In addition, the mixture can be spread out to form a pre-formed film of the mixture in a variety of ways. For example, the mixture can be spread out on the surface of a substrate to form the pre-formed film of the mixture on the surface of the substrate. The mixture can also be filled into a transparent box body so that the mixture can be spread out in the transparent box body. Thus, the pre-formed film of the mixture can be formed in the transparent box body. The pre-formed film in the transparent box body is irradiated by light to form a film which can also be called a polymer wall.

The wavelength of the ultraviolet light for irradiating the pre-formed film of the mixture is 365 nm, the intensity is 0.01 mW/cm² to 30 mW/cm² or others, it is not limited here.

In one embodiment, the time for the ultraviolet light irradiating the pre-formed film of the mixture is 5 min to 70 min, which can be determined by parameters of forming the film in the process of forming the film.

Referring to FIG. 4, the present further provides a method for ultraviolet light intensity detection, using the above-mentioned film or a film prepared by the above-mentioned method for preparing a film. The method for ultraviolet light intensity detection comprises a calibration step, a test step and a result output step.

The calibration step comprises the following step. The film is irradiated by the ultraviolet light with different intensities for a same calibration time, thus the color of the film is changed and a calibration color of the film is obtained, and a correspondence relationship between different ultraviolet light intensities and the calibration colors of the film is obtained.

The test step comprises the following steps. The film is irradiated by ultraviolet light to be tested for a testing time, thus the color of the film is changed and a tested color of the film is obtained, wherein the test time is the same as the calibration time.

The result output step comprises the following steps. The calibration color of the film tested which is the same as the tested color of the film is searched from the correspondence relationship between different ultraviolet light intensities and the calibration colors of the film; and

according to the correspondence relationship between different ultraviolet light intensity, the ultraviolet light intensity which is corresponded to the tested color of the film was found and determined, and the found ultraviolet light intensity which is corresponded to the tested color of the film is the intensity of the ultraviolet light to be tested.

According to the method for ultraviolet light intensity detection provided by the present disclosure, the calibration step is carried on the film prior to the test step to obtain a correspondence relationship between the different ultraviolet intensity and the calibration color of the film. In the test step, by limiting a same test time as the calibration time, after the film is irradiated by the ultraviolet light to be tested, the color of the film can be accurately converted into the color of the film corresponding to ultraviolet light intensity, to accurately find the ultraviolet light intensity corresponding to the tested color of the film in the result output step, that is, to accurately determine the ultraviolet light intensity.

FIG. 6 is a spectrogram obtained by measuring the film under the irradiation of the ultraviolet light for different time, wherein, the wavelength of the ultraviolet light is 365 nm, the intensity of the ultraviolet light is 13.7 mw/cm², for the curve a in FIG. 6, the irradiation time of ultraviolet light is 10 s, and for the curve b in FIG. 6, the irradiation time of ultraviolet light is 30 s. From the spectrum, it can be found that time for the ultraviolet light irradiating the film is different, the reflectivity of the film is different. Therefore, it is necessary to limit a same test time as the calibration time, so that according to the color of the tested film, an exact intensity of the ultraviolet light to be tested can be found from the correspondence relationship between different ultraviolet light intensities and the calibration colors of the film.

In one embodiment, the method for ultraviolet light intensity detection comprises a uniformity test step. Referring to FIG. 5, the uniformity test step comprises: the colors of different portions of the film are obtained after the film is irradiated by the ultraviolet light for a test time, and determining whether the color of different portions of the film is the same; if same, then the intensity of the ultraviolet light to be tested is uniform; if different, the intensity of the ultraviolet light to be tested is not uniform.

In the present disclosure, the colors of the different positions of the film are obtained after the film is irradiated by the ultraviolet light for a test time, whether the intensity of the ultraviolet light to be tested is uniform is determined according to the color of different portions of the film is the same or not. Therefore, according to the method for the ultraviolet light intensity detection, not only the ultraviolet light intensity can be detected, but also the uniformity of the ultraviolet light intensity can be detected.

The method for preparing composition for ultraviolet light intensity detection and the film containing the composition will be described in detail with reference to the following embodiments.

### The First Embodiment

The composition for the ultraviolet light intensity detection provided by the present embodiment comprises nematic mixed crystals, chiral additives, azobenzene monomers, photopolymerizable monomers and benzoin dicarboxylates. The mass ratio of the nematic mixed crystals, the chiral additives, the azobenzene monomers, the photopolymerizable monomer and the benzoin dicarboxylates in the composition is 71.3:8:5:15.2:0.5. In this embodiment, the nematic mixed crystals and the chiral additives are mixed to obtain cholesteric liquid crystals.

The nematic mixed crystal is SLC-1717, manufactured by Shijiazhuang Chengzhi Yonghua Display Materials Co., Ltd.

The chiral additive is

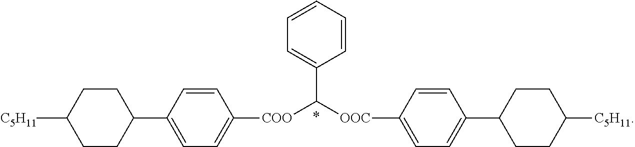

The azobenzene monomer is

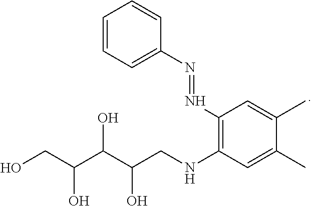 [SMILES: Cc1cc(/N=N/c2ccccc2)c(NCC(O)C(O)C(O)CO)cc1C]

The photopolymerizable monomer is

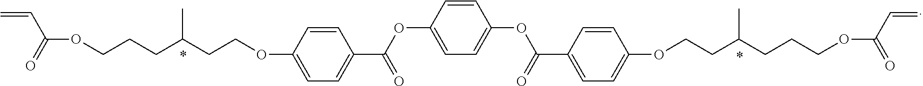

Referring to FIG. 3, the present embodiment also provides a film for ultraviolet light intensity detection, which is a network structure comprising the composition for ultraviolet light intensity detection, which is prepared as follows.

For the first step, according to the mass ratio of 71.3:8:5:15.2:0.5, the nematic mixed crystals, chiral additives, azobenzene monomers, photopolymerizable monomers and benzoin dicarboxylates are mixed to form the mixture.

For the second step, the mixture is filled into a transparent box body so that the mixture can be spread out in the transparent box body. Thus, the pre-formed film of the mixture can be formed in the transparent box body. The transparent box body can be other transparent box bodies.

For the third step, the transparent box body is irradiated by the ultraviolet light passing through a photo mask, so that the pre-formed film of the mixture can be irradiated by the ultraviolet light passing through the transparent box body. The polymerization reactions of photopolymerizable monomers are initiated by the benzoin dicarboxylates in the mixture to obtain a film for ultraviolet light intensity detection. Where, the wavelength of the ultraviolet light is 365 nm, the intensity of the ultraviolet light is 20 mw/cm², and the irradiating time is 40 min.

### The Second Embodiment

The composition for the ultraviolet light intensity detection provided by the present embodiment comprises nematic mixed crystals, chiral additives, cholesteric liquid crystals, azobenzene monomers, photopolymerizable monomers and photoinitiators. The mass ratio of the nematic mixed crystals, the chiral additives, the azobenzene monomers, cholesteric liquid crystals, the photopolymerizable monomer and the benzoin ethers in the composition is 26:19:20:11:2:2.

The nematic mixed crystal is MAT 09-1284, manufactured by Germany Merck company.

The chiral additive comprises two kinds of chiral additives, the mass ratio of which is 1:1:

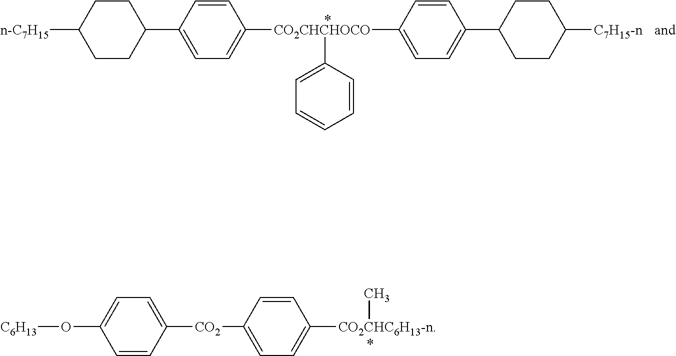

The cholesteric liquid crystals are

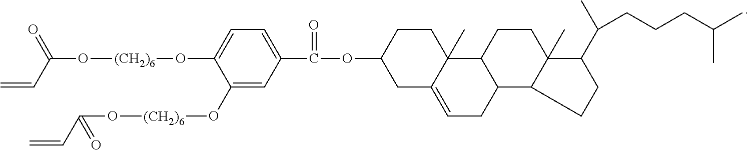

The azobenzene monomer is

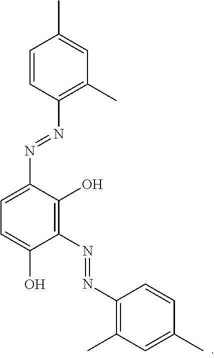 [SMILES: Cc1ccc(/N=N/c2ccc(O)c(/N=N/c3ccc(C)cc3C)c2O)c(C)c1]

The photopolymerizable monomer is

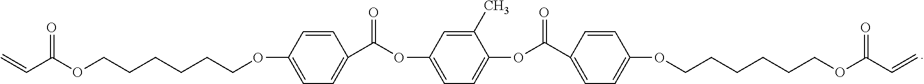 [SMILES: C=CC(=O)OCCCCCCOc1ccc(C(=O)Oc2ccc(OC(=O)c3ccc(OCCCCCCOC(=O)C=C)cc3)c(C)c2)cc1]

Referring to FIG. 3, the present embodiment also provides a film for ULTRAVIOLET light intensity detection, which is a network structure comprising the composition for ULTRAVIOLET light intensity detection, which is prepared as follows.

For the first step, according to the mass ratio of 26:19:20:11:2:2, the nematic mixed crystals, chiral additives, cholesteric liquid crystals, azobenzene monomers, photopolymerizable monomers and benzoin ethers are mixed to form the mixture.

For the second step, the mixture is spread out on the surface of a substrate. Thus, the pre-formed film of the mixture can be formed on the surface of the substrate.

For the third step, the surface of the substrate is irradiated by the ultraviolet light passing through a photo mask, so that the pre-formed film of the mixture on the surface of the substrate can be irradiated by the ultraviolet light. The polymerization reactions of photopolymerizable monomers are initiated by the benzoin ethers in the mixture to obtain a film for ultraviolet light intensity detection. Where, the wavelength of the ultraviolet light is 365 nm, the intensity of the ultraviolet light is 0.01 mw/cm², and the irradiating time is 70 min.

### The Third Embodiment

The composition for the ultraviolet light intensity detection provided by the present embodiment comprises nematic mixed crystals, chiral additives, cholesteric liquid crystals, azobenzene monomers, photopolymerizable monomers and benzoin butyl ethers. The mass ratio of the nematic mixed crystals, the chiral additives, the azobenzene monomers, cholesteric liquid crystals, the photopolymerizable monomer and the benzoin butyl ethers in the composition is 65.99:5:20:2:7:0.01.

The nematic mixed crystal is ZBE 5192, manufactured by JNC Petrochemical Co., Ltd., Japan.

The chiral additive is

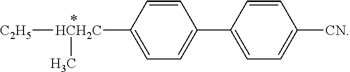

The cholesteric liquid crystals are

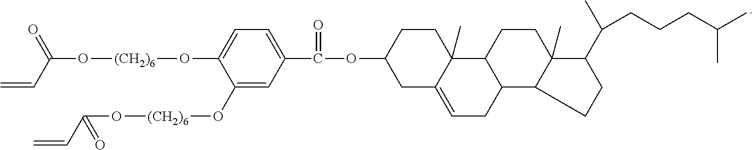

The azobenzene monomer comprises two kinds of azobenzene monomer, the mass ratio of which is 2:1:

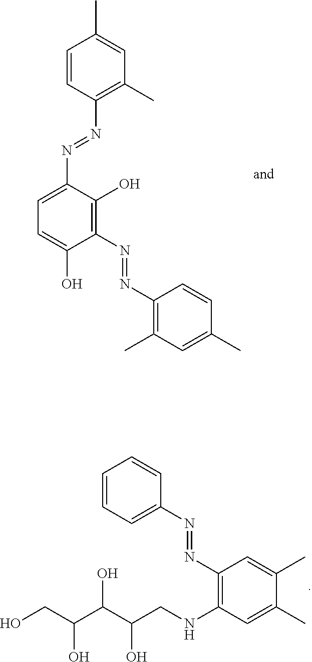 [SMILES: Cc1ccc(/N=N/c2ccc(O)c(/N=N/c3ccc(C)cc3C)c2O)c(C)c1 ; Cc1cc(/N=N/c2ccccc2)c(NCC(O)C(O)C(O)CO)cc1C]

The photopolymerizable monomer comprises two kinds of photopolymerizable monomer, the mass ratio of which is 2:1:

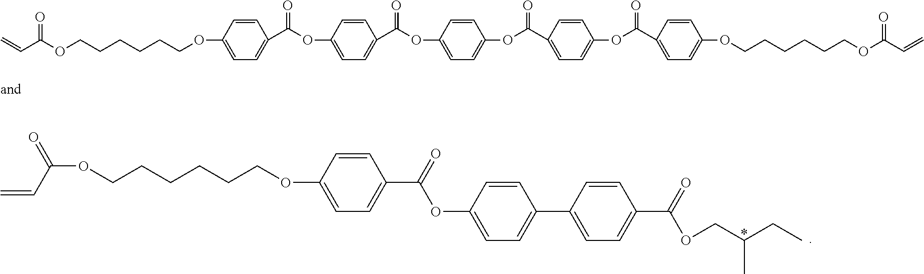

Referring to FIG. 3, the present embodiment also provides a film for ultraviolet light intensity detection, which is a network structure comprising the composition for ultraviolet light intensity detection, which is prepared as follows.

For the first step, according to the mass ratio of 65.99:5:20:2:7:0.01, the nematic mixed crystals, chiral additives, cholesteric liquid crystals, azobenzene monomers, photopolymerizable monomers and benzoin butyl ethers are mixed to form the mixture.

For the second step, the mixture is spread out on the surface of a substrate. Thus, the pre-formed film of the mixture can be formed on the surface of the substrate.

For the third step, the surface of the substrate is irradiated by the ultraviolet light passing through a photo mask, so that the pre-formed film of the mixture on the surface of the substrate can be irradiated by the ultraviolet light. The polymerization reactions of photopolymerizable monomers are initiated by the benzoin butyl ethers in the mixture to obtain a film for ultraviolet light intensity detection. Where, the wavelength of the ultraviolet light is 365 nm, the intensity of the ultraviolet light is 30 mw/cm², and the irradiating time is 5 min.

### The Fourth Embodiment

The composition for the ultraviolet light intensity detection provided by the present embodiment comprises nematic mixed crystals, chiral additives, cholesteric liquid crystals, azobenzene monomers, photopolymerizable monomers, benzoin butyl ethers and benzoin ethers. The mass ratio of the nematic mixed crystals, the chiral additives, the azobenzene monomers, cholesteric liquid crystals, the photopolymerizable monomer, benzoin butyl ethers and benzoin ethers in the composition is 31:19:15:11:22:1:1.

The nematic mixed crystal is ZBE 5192 (manufactured by JNC Petrochemical Co., Ltd., Japan) and SLC-1717 (manufactured by Shijiazhuang Chengzhi Yonghua Display Materials Co., Ltd.), the mass ratio of which is 3:2.

The chiral additive is

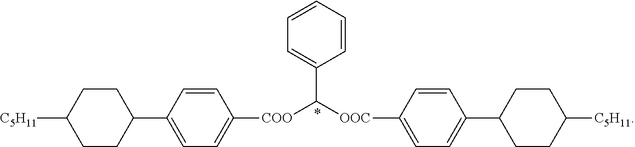

The cholesteric liquid crystals are

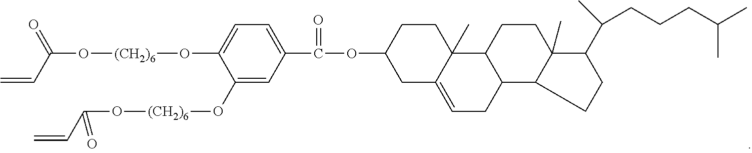

The azobenzene monomer is:

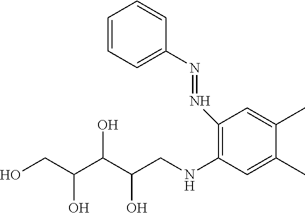 [SMILES: Cc1cc(/N=N/c2ccccc2)c(NCC(O)C(O)C(O)CO)cc1C]

The photopolymerizable monomer is

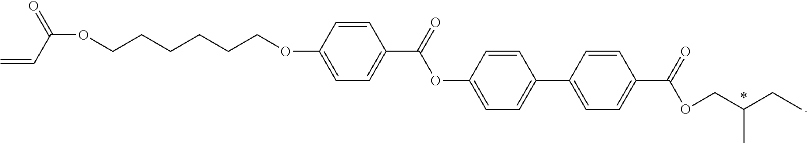 [SMILES: C=CC(=O)OCCCCCCOc1ccc(C(=O)Oc2ccc(-c3ccc(C(=O)OCC(C)CC)cc3)cc2)cc1]

Referring to FIG. 3, the present embodiment also provides a film for ULTRAVIOLET light intensity detection, which is a network structure comprising the composition for ULTRAVIOLET light intensity detection, which is prepared as follows.

For the first step, according to the mass ratio of 31:19:15:11:22:1:1, the nematic mixed crystals, chiral additives, cholesteric liquid crystals, azobenzene monomers, photopolymerizable monomers, benzoin butyl ethers and benzoin ethers are mixed to form the mixture.

For the second step, the mixture is spread out on the surface of a substrate. Thus, the pre-formed film of the mixture can be formed on the surface of the substrate.

For the third step, the surface of the substrate is irradiated by the ultraviolet light passing through a photo mask, so that the pre-formed film of the mixture on the surface of the substrate can be irradiated by the ultraviolet light. The polymerization reactions of photopolymerizable monomers are initiated by the benzoin butyl ethers and benzoin ethers in the mixture to obtain a film for ultraviolet light intensity detection. Where, the wavelength of the ultraviolet light is 365 nm, the intensity of the ultraviolet light is 12 mw/cm², and the irradiating time is 50 min.

### The Fifth Embodiment

The composition for the ultraviolet light intensity detection provided by the present embodiment comprises nematic mixed crystals, chiral additives, azobenzene monomers, photopolymerizable monomers and benzoin ethers. The mass ratio of the nematic mixed crystals, the chiral additives, the azobenzene monomers, the photopolymerizable monomer and the benzoin ethers in the composition is 85.99:2:3:8:1.01.

The nematic mixed crystal is SLC-1717, manufactured by Shijiazhuang Chengzhi Yonghua Display Materials Co., Ltd.

The chiral additive is

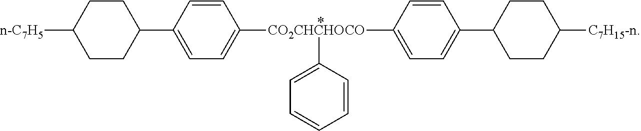

The azobenzene monomer is

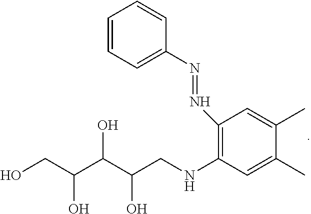 [SMILES: Cc1cc(/N=N/c2ccccc2)c(NCC(O)C(O)C(O)CO)cc1C]

The photopolymerizable monomer is

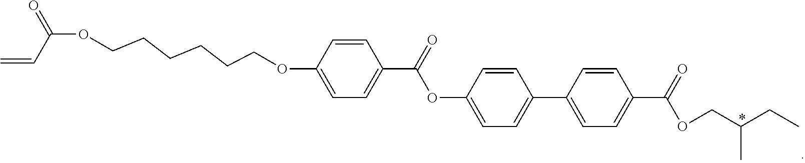 [SMILES: C=CC(=O)OCCCCCCOc1ccc(C(=O)Oc2ccc(-c3ccc(C(=O)OCC(C)CC)cc3)cc2)cc1]

Referring to FIG. 3, the present embodiment also provides a film for ultraviolet light intensity detection, which is a network structure comprising the composition for ultraviolet light intensity detection, which is prepared as follows.

For the first step, according to the mass ratio of 85.99:2:3:8:1.01, the nematic mixed crystals, chiral additives, azobenzene monomers, photopolymerizable monomers and benzoin ethers are mixed to form the mixture.

For the second step, the mixture is filled into a transparent box body so that the mixture can be spread out in the transparent box body. Thus, the pre-formed film of the mixture can be formed in the transparent box body. The transparent box body can be other transparent box bodies.

For the third step, the transparent box body is irradiated by the ultraviolet light passing through a photo mask, so that the pre-formed film of the mixture can be irradiated by the ultraviolet light passing through the transparent box body. The polymerization reactions of photopolymerizable monomers are initiated by the benzoin ethersin the mixture to obtain a film for ultraviolet light intensity detection. Where, the wavelength of the ultraviolet light is 365 nm, the intensity of the ultraviolet light is 18 mw/cm2, and the irradiating time is 35 min.

In the description of the above embodiments, the particular features, structures, materials, or features may be combined in any one(s) of embodiments or examples in suitable manner.

The foregoing are only the specific embodiments of the present disclosure, but the scope of the present disclosure is not limited thereto, and any person skilled in the art will be able to easily think of variations or substitutions within the technical scope disclosed in this disclosure, the variations or substitutions are within the scope of the present disclosure. Accordingly, the scope of protection of the present disclosure should be based on the protection scope of the claims.

What is claimed is:

1. A composition for ultraviolet light intensity detection comprising: nematic mixed crystals, chiral additives, cholesteric liquid crystals, azobenzene monomers, photopolymerizable monomers and a photoinitiators.

2. The composition for ultraviolet light intensity detection of claim 1, wherein a clearing point temperature of the nematic mixed crystal is 80° C.˜120° C.

3. The composition for ultraviolet light intensity detection of claim 1, wherein an optical rotation direction of the chiral additive is consistent with that of the cholesteric liquid crystals.

4. The composition for ultraviolet light intensity detection of claim 1, wherein the chiral additive is selected from a group consisting of

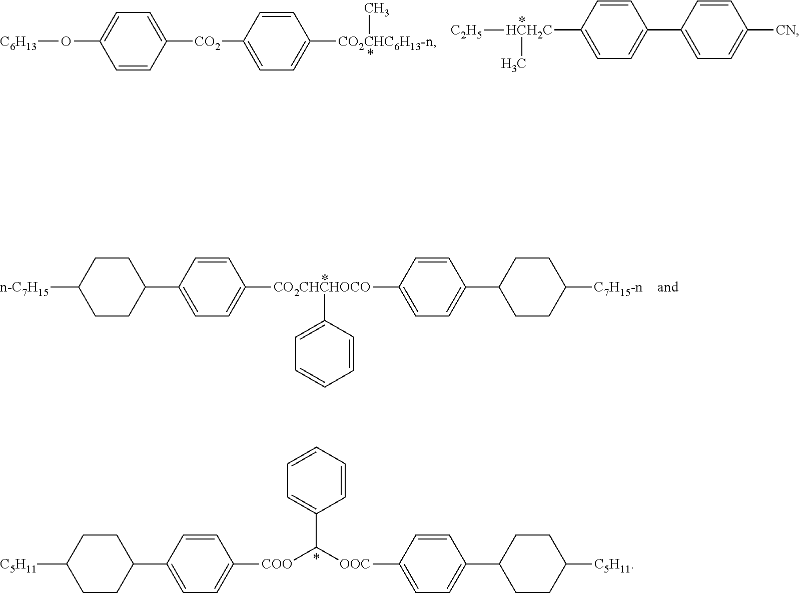

5. The composition for ultraviolet light intensity detection of claim 3, wherein the chiral additive is selected from a group consisting of

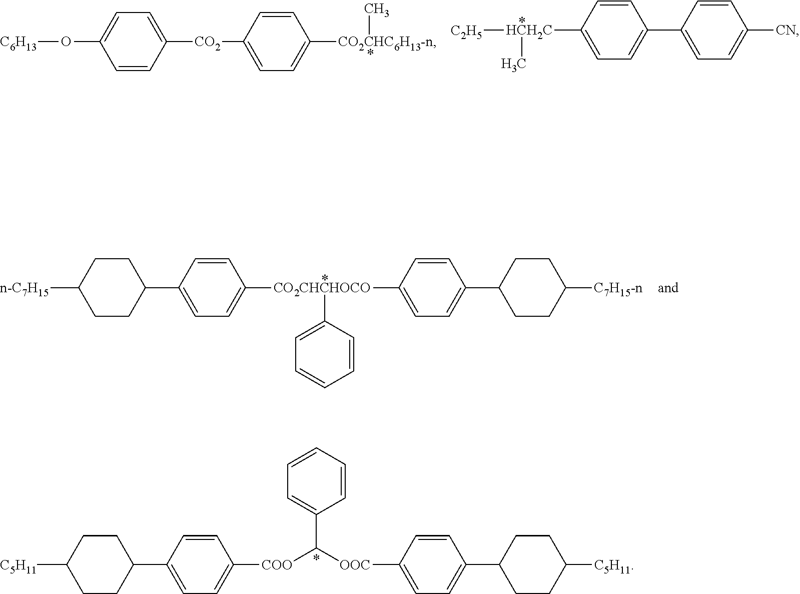

6. The composition for ultraviolet light intensity detection of claim 1, wherein the cholesteric liquid crystals are

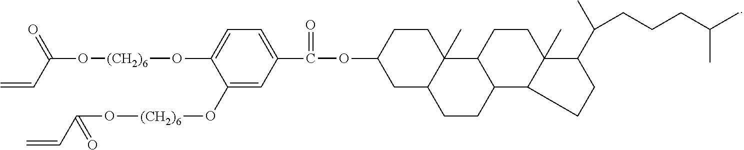

7. The composition for ultraviolet light intensity detection of claim 1, wherein the azobenzene monomer is selected from a group consisting of

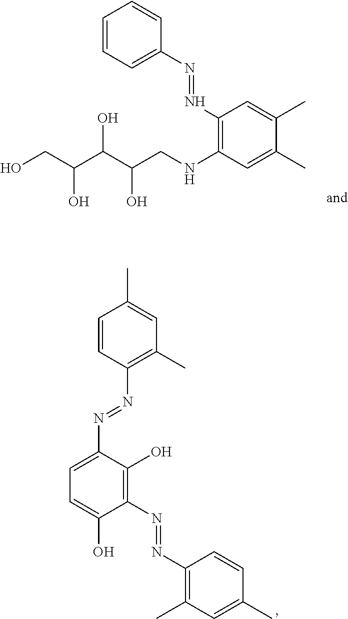 [SMILES: Cc1cc(/N=N/c2ccccc2)c(NCC(O)C(O)C(O)CO)cc1C ; Cc1ccc(/N=N/c2ccc(O)c(/N=N/c3ccc(C)cc3C)c2O)c(C)c1]

8. The composition for ultraviolet light intensity detection of claim 1, wherein the azobenzene monomer is selected from a group consisting of

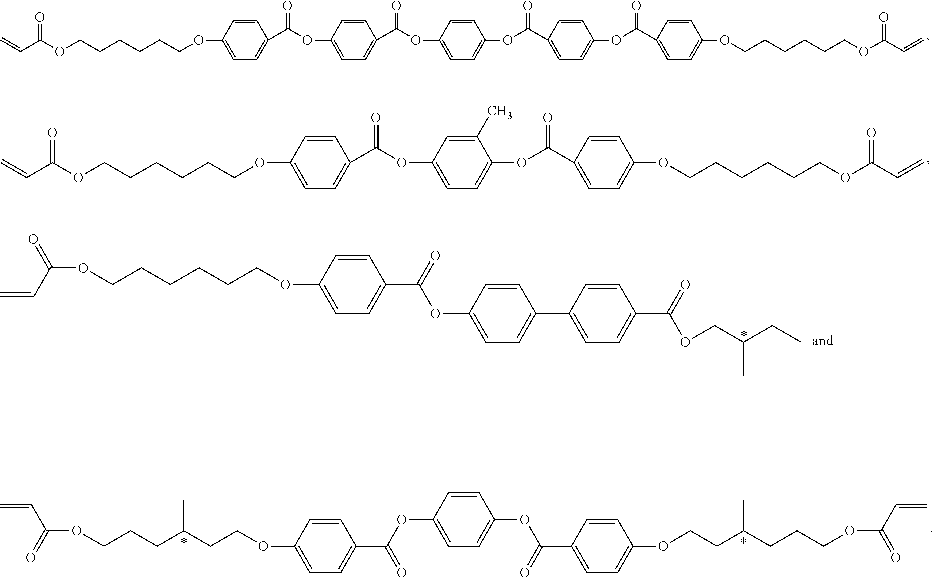

9. The composition for ultraviolet light intensity detection of claim 1, wherein the photoinitiator is selected from a group consisting of benzoin dicarboxylate, benzoin ethers and benzoin ethers.

10. The composition for ultraviolet light intensity detection of claim 1, wherein the mass ratio of the nematic mixed crystal, the chiral additive, the cholesteric liquid crystals, the azobenzene monomer, the photopolymerizable monomer and the photoinitiator in the composition is (26˜85.99):(5˜19):(0˜20):(2˜11):(7˜22):(0.01˜2).

11. A film for ultraviolet light intensity detection, obtainable from the composition for ultraviolet light intensity detection of claim 1.

12. The film for ultraviolet light intensity detection of claim 11, wherein the film has a network structure.

13. A method for preparing a film, used to prepare the film for ultraviolet light intensity detection obtainable from a composition for ultraviolet light intensity detection, wherein the composition for ultraviolet light intensity detection comprises nematic mixed crystals, chiral additives, cholesteric liquid crystals, azobenzene monomers, photopolymerizable monomers and a photoinitiators, wherein the method comprises:
mixing the photopolymerizable monomer, the photoinitiator, the cholesteric liquid crystals, the azobenzene monomer, the nematic mixed crystal and the chiral additive to form a mixture; and
spreading out the mixture to form a pre-formed film of the mixture, and irradiating the pre-formed film by light, so that polymerization reaction of photopolymerizable monomers is initiated by the photoinitiator in the mixture to form a film for ultraviolet light intensity detection.

14. The method for preparing the film of claim 13, wherein the method further comprises spreading out the mixture on a surface of a substrate, and forming the pre-formed film of the mixture on the surface of the substrate.

15. The method for preparing the film of claim 13, wherein the method further comprises filling the mixture into a transparent box body so that the mixture can be spread out in the transparent box body, and forming the pre-formed film of the mixture in the transparent box body.

16. The method for preparing a film of claim 13, wherein the method further comprises irradiating the pre-formed film of the mixture by a light passing through a photo mask.

17. The method for preparing a film of claim 13, wherein the light irradiating the pre-formed film of the mixture is an ultraviolet light, a wavelength of the ultraviolet light is 365 nm, an intensity of the ultraviolet light is 0.01 mw/cm²˜30 mw/cm².

18. The method for preparing a film of claim 17, wherein an irradiating time for the pre-formed film of the mixture is 5 min˜70 min.

19. A method for ultraviolet light intensity detection, using a film obtainable from a composition for ultraviolet light intensity detection of wherein the composition for ultraviolet light intensity detection comprises nematic mixed crystals, chiral additives, cholesteric liquid crystals, azobenzene monomers, photopolymerizable monomers and a photoinitiators, wherein the method comprises:
irradiating the film in a calibration step by ultraviolet light with different intensities for a same calibration time to change a color of the film and obtain a calibration color of the film, and obtaining a correspondence relationship between different ultraviolet light intensities and the calibration colors of the film;
irradiating the film in a test step by ultraviolet light to be tested for a testing time to change a color of the film and obtain a tested color of the film, wherein the testing time is the same as the calibration time;
searching for the calibration color of the film in a result output step that is the same as the tested color of the film from the correspondence relationship between different ultraviolet light intensities and the calibration colors of the film; and
according to the correspondence relationship between different ultraviolet light intensities and the calibration colors of the film, finding and determining the ultraviolet light intensity corresponding to the tested color of the film, wherein the found ultraviolet light intensity corresponding to the tested color of the film is the intensity of the ultraviolet light to be tested.

20. The method for ultraviolet light intensity detection of claim 19, further comprising a uniformity test step, wherein the uniformity test step comprises:
obtaining colors of different portions of the film after the film is irradiated by the ultraviolet light to be tested for a test time, and determining whether the color of different portions of the film is the same; and
when the color of different portions of the film is the same, the intensity of the ultraviolet light to be tested is uniform; when the color of different portions of the film is different, the intensity of the ultraviolet light to be tested is not uniform.
